(19) United States
(12) Patent Application Publication
(10) Pub. No.: US 2009/0123364 A1
(43) Pub. Date: May 14, 2009

(54) Process for Hydrogen Production

(76) Inventors: Jonathan Alec Forsyth, Berkshire (GB); Roger Neil Harper, Surrey (GB)

Correspondence Address: NIXON & VANDERHYE, PC, 901 NORTH GLEBE ROAD, 11TH FLOOR, ARLINGTON, VA, 22203, US

(21) Appl. No.: 12/227,061

(22) PCT Filed: Apr. 26, 2007
(86) PCT No.: PCT/GB2007/001545

§ 371 Date: Nov. 6, 2008

(30) Foreign Application Priority Data
May 8, 2006 (EP) 06252431.9

(51) Int. Cl. C01B 3/26

(52) U.S. Cl. 423/651

(57) ABSTRACT

A process is described for the production of hydrogen from a hydrogen-containing compound within a reactor comprising a first and a second zone separated by a selective hydrogen-permeable membrane, in which a hydrogen-producing reaction occurs in the first zone and hydrogen permeates from the first zone to the second zone through the selective hydrogen-permeable membrane, in which a sweep gas stream is combined with permeated hydrogen in the second zone, wherein the partial pressure in the second zone of the reactor is maintained at a level of greater than 30 psi (207 kPa).

This invention relates to the production of hydrogen for power generation, more specifically to the generation of hydrogen from a hydrogen-containing compound, such as a hydrocarbon, in a reactor comprising a membrane that is selectively permeable to hydrogen.

The combustion of fossil fuels to generate electrical power and/or pressurised steam results in the formation of carbon dioxide, which is a so-called greenhouse gas. In order to reduce atmospheric emissions of such greenhouse gases to the atmosphere, increasing attention is being focussed on hydrogen as a fuel, as the energy produced per unit mass is high, and the only combustion product is water. However, most hydrogen currently produced is derived from fossil fuels, for example from refining processes such as catalytic reforming, or through processes for producing syngas from hydrocarbons, such as steam reforming, autothermal reforming or partial oxidation. Thus, the production of hydrogen still results in the production of carbon dioxide. Thus, it would be advantageous if carbon dioxide emissions to the atmosphere could be eliminated, or at least reduced, while still benefiting from the use of hydrogen as an energy source.

A process for the production of hydrogen from carbon-based fuels, and its separation from other gases such as oxides of carbon is described, for example, in U.S. Pat. No. 4,810,485, which relates to a reactor for a hydrogen-forming reaction, for example a steam reforming or water-gas-shift reaction, which additionally comprises a hydrogen-ion porous foil, such as a nickel foil. The hydrogen-ion porous foil is capable of selectively removing hydrogen produced in the hydrogen-forming reaction. The removal of hydrogen from the steam reforming portion of the reactor constantly shifts the equilibrium therein, resulting in more hydrogen production and enabling higher hydrogen yields to be achieved. Use of the reactor in a process to generate hydrogen from methane by steam reforming is stated to enable hydrogen yields of 90% to be achieved.

WO02/70402 also describes a reactor for the reforming of a vapourisable hydrocarbon to produce hydrogen and carbon dioxide, which reactor comprises a hydrogen-permeable membrane. The reactor is heated by flameless distributed combustion in a region of the reactor separate to that in which the steam-reforming and hydrogen separation processes occur. The process is directed towards producing hydrogen and carbon dioxide, while minimising the production of carbon monoxide. The hydrogen is suitable for use in a fuel cell for generating electricity. Methane conversions of 98% and a hydrogen permeation ratio of 99% are stated to be achievable.

U.S. Pat. No. 5,741,474 describes the production of high-purity hydrogen by feeding a hydrocarbon or an oxygen atom-containing hydrocarbon, water and oxygen to a reactor comprising a catalyst for steam reforming and partial oxidation, in which the hydrogen produced is separated within the reactor by use of selective hydrogen-permeable membrane tubes to produce a high purity hydrogen stream. Combining steam reforming with partial oxidation is stated to improve the heat efficiency of the process and also to improve hydrogen yields.

Itoh et al in Catalysis Today, 2003, vol 82, pp 119-125 describe a process for dehydrogenation of cyclohexane using a palladium-membrane reactor for selectively removing hydrogen, in which the rate of dehydrogenation and the rate of hydrogen recovery is enhanced when the pressure difference across the membrane is increased. It is stated to be advantageous to maintain the pressure on the permeate-side of the membrane as low as possible in order to improve the rate of hydrogen production. The hydrogen recovery side of the membrane is stated to be kept at atmospheric pressure or less in order to maintain hydrogen flux.

Although maximising reactant conversion and hydrogen yields is desirable, the need to maximise the hydrogen partial pressure gradient across the membrane typically means that only low pressures or partial pressures of separated hydrogen are produced. Thus, for applications requiring high hydrogen pressures, for example combustion using a gas turbine, expensive compression techniques would be needed. Reducing or even eliminating the need for gas compression is therefore desirable.

According to a first aspect of the present invention, there is provided a process for the production of hydrogen from a hydrogen-containing compound in a reactor having a first zone and a second zone separated by a selective hydrogen-permeable membrane, which process comprises the steps of;
(a) feeding a hydrogen-containing compound into the first zone of the reactor;
(b) maintaining conditions therein such that the hydrogen-containing compound reacts to produce hydrogen;
(c) maintaining conditions in the second zone of the reactor such that hydrogen produced in the first zone permeates the selective hydrogen-permeable membrane to the second zone;
(d) removing from the first zone of the reactor a stream comprising components that have not permeated the selective hydrogen-permeable membrane; and
(e) removing from the second zone of the reactor a stream comprising hydrogen that has permeated across the selective hydrogen-permeable membrane, the hydrogen partial pressure being maintained at a value of greater than 30 psi (207 kPa),
   characterised in that a sweep gas is also fed to the second zone of the reactor.

The process of the present invention enables high pressures of hydrogen to be obtained when using a reactor comprising a selective hydrogen-permeable membrane. The partial pressure of hydrogen in the second zone of the reactor is maintained at a level of greater than 30 psi (207 kPa), preferably 3 bar (300kPa) or more, such as 10 bar or more (1 MPa). This is advantageous, as it allows a reduction in the use of energy intensive and expensive apparatus that would otherwise be required to compress the permeated hydrogen to higher pressures, such as for use as a fuel for a gas turbine.

A sweep gas is fed at pressure to the second zone of the reactor. Use of a hydrogen stream that is diluted with sweep gas is advantageous for applications in which a pure hydrogen feed is unsuitable, such as the combustion of hydrogen in a gas turbine. The heat liberated by a pure feed of hydrogen, particularly at pressures typically required for a gas turbine, would damage turbine equipment and render its operation unsafe. Another advantage of using a sweep gas is that it can be fed to the second zone of the reactor at pressures which may be required further downstream in the process, which reduces the surface area of membrane that would otherwise be necessary to produce a pure hydrogen stream at such pressures.

The use of a sweep gas can provide a stream of hydrogen not only at the desired pressure of use, but also with a hydrogen concentration suitable to ensure safe and effective gas turbine operation. By producing a diluted hydrogen stream of suitable concentration at the source of production, the need for additional processing steps to modify further the composition of the hydrogen stream before being fed to the gas turbine is eliminated, which reduces the complexity of the process together with associated operating and capital costs.

The sweep gas is preferably an inert gas, which will not react with the hydrogen under the conditions within the second zone of the reactor. The sweep gas is preferably selected from one or more of nitrogen, argon and steam. The molar concentration of hydrogen (H₂) in the mixture of sweep gas and hydrogen is preferably up to 80%, more preferably in the range of from 10% to 70%. Yet more preferably, the molar fraction of hydrogen is in the range of from 40% to 60%.

Use of steam and/or nitrogen as the sweep gas is particularly advantageous for production sites that already have existing supplies of pressurised steam and/or nitrogen, which therefore avoids, or at least reduces, the need for additional pressurising equipment that would otherwise be required to achieve the desired sweep gas pressure.

Typically, a hydrogen stream fed to a gas turbine requires a total pressure of at least 15 bara (1.5 MPa), such as in the range of from 20 to 30 bara (2 to 3 MPa). Preferably, the total pressure of the hydrogen and sweep gas in the second zone of the reactor is at least 3 bara (0.3 MPa). Higher pressures can also be used, such as at least 10 bara (1 MPa), for example at least 15 bara (1.5 MPa), or at least 20 bara (2 MPa), such as in the range of from 20 to 30 bara (2 to 3 MPa).

Conditions in the first zone of the reactor are maintained such that hydrogen is capable of permeating through the selective hydrogen-permeable membrane from the first zone to the second zone. This is achieved by maintaining a higher hydrogen partial pressure within the first zone compared to the second zone.

The reactor of the present invention has two zones. In the first zone, a reaction takes place in which hydrogen is produced from a hydrogen-containing compound which is fed into the first reaction zone through a suitable inlet. The second zone receives hydrogen that permeates the selective hydrogen-permeable membrane separating the two zones.

The reaction in the first zone of the reactor is preferably a steam reforming and/or, partial oxidation reaction, which typically produces hydrogen from a hydrogen-containing compound, such as a hydrocarbon or an oxygenated organic compound, in the presence of steam and/or oxygen. Suitable hydrogen-containing compounds include natural gas (either supplied direct from a gas field through a pipeline, for example, or in the form of liquefied natural gas), liquefied petroleum gas (e.g. propane, butane), alcohols such as methanol or ethanol, or higher hydrocarbons, such as C₆-C₁₀ alkanes. Preferably, the hydrogen-containing compound is natural gas.

Steam reforming reactions result in the production of hydrogen and oxides of carbon. The expression “oxides of carbon” refers to a mixture of carbon monoxide and carbon dioxide, and will henceforth be referred to as COX. Preferably, the process is catalysed by a steam reforming catalyst, examples of which include compositions comprising a metal selected from one or more of nickel, ruthenium, platinum, palladium, rhodium, rhenium and iridium, optionally supported on a substrate selected from, for example, one or more of magnesia, alumina, silica and zirconia.

Optionally, and preferably, oxygen is also fed to the first reaction zone through a suitable inlet, either in the form of air, or preferably in the form of purified oxygen to minimise the concentration of inert diluent gases in the first reactor zone. Purified oxygen suitable for use in the present invention may be produced by, for example, an air separation unit from fractional distillation of liquid air, or by using a selective oxygen-permeable membrane. The oxygen can be fed either together with or separately from the hydrogen-containing compound. The presence of oxygen causes partial oxidation of the hydrogen-containing compound in addition to the steam reforming reaction.

The exothermic partial oxidation reaction generates heat which can be used to offset the cooling effect of the endothermic steam reforming reaction. This reduces the quantity of heat required for maintaining temperatures within the reactor, and consequently improves the energy efficiency of the process. In one embodiment of the invention a catalyst comprising one or more of nickel, ruthenium, platinum and rhodium supported on a support such as alumina, zirconia or silica, is present in the first zone of the reactor, which is active towards both steam reforming and partial oxidation.

In steam reforming reactions, the first zone of the reactor is typically maintained at a temperature in the range of from 1000 to 1500° C., while in the case of a combined partial oxidation and steam reforming process, in which both oxygen and steam are present in the first zone of the reactor, lower temperatures are required, such as temperatures in the range of from 200 to 800° C., more preferably in the range of from 450 to 650° C. In embodiments relating to the combined partial oxidation and steam reforming of hydrocarbons, particularly natural gas, an advantage of the lower temperature of the combined reaction is that less coking may occur within the first zone of the reactor, which may avoid the need for any pre-reforming of the hydrocarbon feed, thus further improving the operating and energy efficiency of the process.

The pressure within the first zone of the reactor is preferably maintained in the range of from 5 to 200 bara (0.5 to 20 MPa), more preferably in the range of from 10 to 90 bara (1.0 to 90 MPa), even more preferably in the range of from 25 to 55 bara (2.5 to 5.5 MPa).

A water gas shift reaction may additionally occur within the first zone of the reactor, wherein steam and carbon monoxide react to product carbon dioxide and hydrogen. Optionally, the first zone may additionally comprise a catalyst active for a water gas shift-reaction which may be distributed such that an increased quantity or concentration of water gas shift catalyst is present in higher concentrations towards the outlet of the first zone, which further improves hydrogen yield.

In steam reforming and partial oxidation of hydrocarbon compounds or oxygenated hydrocarbon compounds, COX is produced in addition to hydrogen. The COₓ does not permeate the selective hydrogen-permeable membrane to any significant extent, and so remains within the first zone of the reactor from which it is removed through a suitable outlet. Preferably, conditions are maintained such that carbon dioxide is the predominant carbon oxide produced by the reaction(s) within the first zone of the reactor, as the formation of carbon dioxide results in higher hydrogen yields. Carbon dioxide is also less toxic than carbon monoxide.

In another embodiment of the present invention, the reaction that produces hydrogen is a water gas shift reaction, in which carbon monoxide is converted to carbon dioxide in the presence of steam, which steam is the hydrogen-containing compound. Two categories of water gas shift (WGS) reactions are known in the art, namely high temperature and low temperature WGS. High temperature WGS reactions typically operate at temperatures in the range of from 250 to 400° C. in the presence of a catalyst, examples of which would be known to those skilled in the art, and which include compositions comprising iron, nickel, chromium or copper, such as chromia-doped iron catalysts. Low temperature WGS reactions are carried out at a lower temperature, typically in the range of from 150 to 250° C., and result in improved CO conversions. Examples of low temperature WGS catalysts include compositions comprising copper oxide or copper supported on other transition metal oxides such as zirconia; zinc supported on supports such as silica, alumina, zirconia; and compositions comprising a noble metal such as platinum, rhenium, palladium, ruthenium, rhodium or gold on suitable support such as silica, alumina or zirconia.

Often high temperature and low temperature WGS are used in combination. High temperature WGS is used for the rapid conversion of relatively high concentrations of CO to CO₂ and hydrogen (in the presence of steam). As higher CO conversions are favoured by lower temperatures, low temperature WGS is generally used to reduce CO concentrations in streams having relatively low CO concentrations, for example for “polishing” process streams resulting from a high temperature WGS reaction. The combination of the two types of WGS reaction enables rapid conversion of CO and high hydrogen yields.

The selective hydrogen-permeable membrane in the reactor separates the first and second zones of the reactor. Materials capable of allowing the selective-permeation of hydrogen, and which are preferred in the present invention include either palladium or an alloy of palladium, for example an alloy with silver, copper or gold. The membrane may comprise a sheet or film of the selectively permeable material. Alternatively the membrane may be a composite membrane having a layer of the selective hydrogen-permeable material on a porous carrier, which reduces the quantity of the selectively hydrogen-permeable material required, while ensuring the membrane remains robust. When using palladium or palladium-alloy membranes, the temperatures within the first and second zones of the reactor are preferably maintained at 250° C. or above. The brittleness of the palladium or palladium-alloy membrane tends to be higher at lower temperatures, rendering it more susceptible to damage. Preferably, the temperature within the second zone of the reactor is similar to the temperature within the first zone of the reactor, optionally by heating the sweep gas fed thereto. Thus, in a preferred embodiment of the invention, the sweep gas fed to the second zone of the reactor is heated to a temperature of 250° C. or above. Not only does this reduce brittleness of the palladium membrane, but it also reduces any further heating of the hydrogen containing stream that may additionally be required when being fed to a power generator.

The hydrogen-containing compound may undergo one or more pre-treatment stages before being fed to the first zone of the reactor, for example desulphurisation and/or pre-reforming. Desulphurisation removes sulphur and/or sulphur compounds which could otherwise poison steam reforming and/or partial oxidation catalysts, or damage the selective hydrogen-permeable membrane. Desulphurisation is particularly suitable for hydrocarbon supplies having high sulphur content, in which the sulphur may originate from the production source, such as an oil or gas field for example, or which may be added as a stenching agent, such as in commercial supplies of natural gas or LPG (liquefied petroleum gas) fuels. Preferably, the sulphur concentration in the feed to the first zone of the reactor is less than 1 ppm (expressed as elemental sulphur).

The process may optionally comprise a pre-reforming step, in which the hydrogen-containing compound is reacted with steam, typically at a temperature in the range of from 200 to 1500° C., preferably in the range of from 400 to 650° C., before being fed to the first zone of the reactor. Pre-reforming is particularly advantageous for natural gas, as it removes higher hydrocarbons, such as ethane, propane and butanes, by converting them into carbon monoxide and/or carbon dioxide together with hydrogen. Pre-reforming reduces the potential for carbon or coke generation during the subsequent steam reforming and/or partial oxidation reactions in the first zone of the reactor, while increasing the overall yield of hydrogen. The pre-reforming process is preferably catalysed.

Preferably, the hydrogen separated in the first reactor and removed from the second zone of the first reactor is fed to an electric power generator, wherein the electrical power is produced from the energy released on the conversion of hydrogen into water. Preferably, this is achieved by combustion of the hydrogen in the presence of air, although the oxygen could alternatively derive from a source richer or poorer in oxygen than air. Generation of electrical power is suitably and preferably achieved with a gas-turbine. More preferably, a combined cycle gas turbine is used to generate both electricity and steam, wherein electricity is produced directly from the turbine operation, while heat from the hot turbine exhaust gases are used to produce steam through heat exchange, which steam can be used to drive a further turbine for electricity generation. Alternatively heat from the exhaust can be used for heating purposes, for example to heat a site supply of pressurised steam for use in chemicals or refinery processes.

Optionally, the process of the present invention may have more than one reactor with a selective hydrogen-permeable membrane. The reaction in any additional membrane-containing reactor may be the same reaction as that carried out in the first zone of the first reactor, or alternatively may be a different reaction.

In one embodiment of the present invention, there is a series of two reactors, each reactor comprising a selective hydrogen-permeable membrane, in which a combined steam reforming and partial oxidation process takes place in the first zone of the first reactor, and the product stream from the first zone of the first reactor is fed to the first zone of the second reactor, in which a WGS reaction takes place. In another embodiment of the invention, there is a series of four reactors, in which the first two reactors are steam reforming and partial oxidation reactors with selective hydrogen permeable membranes, and the second two are WGS reactors with selective hydrogen permeable membranes, wherein the product stream removed from the first reaction zone of one reactor is fed to the first zone of the subsequent reactor.

Not all the hydrogen produced in the one or more reactors may permeate the one or more selective hydrogen permeable membranes, and is therefore removed in the product stream of the first zone of the one or more reactors. In one embodiment of the invention, energy from the non-permeated hydrogen is extracted by feeding the product stream of one or more of the reactors, to a combustor, wherein it is reacted with oxygen to convert, for example, hydrogen to water, carbon monoxide to carbon dioxide, and unreacted hydrocarbons or oxygenated organic compounds to carbon dioxide and water. The heat liberated on combustion can be captured by transferring heat from the product stream of the combustor to one or more of the process streams of the present invention, such as a feed stream to the first zone of the reactor or reactors, or to generate steam for use elsewhere, thus further increasing the heat efficiency of the process. A combustor may be advantageously employed for process streams in which the molar concentration of carbon monoxide is less than 10% and/or the molar concentration of hydrogen is less than 20%.

By capturing the heat of combustion of any residual carbon monoxide and unreacted hydrogen-containing compound and any unseparated hydrogen, the need for a series of water gas shift reactors to maximise hydrogen yield and reduce carbon monoxide concentrations is reduced. Thus, in a preferred embodiment of the present invention, there are one or more reactors for the partial oxidation and/or steam reforming of hydrocarbons, but no additional reactors for WGS reactions. This minimises the number of reactors, resulting in reduced process complexity and less capital and operating expenditure.

In a preferred embodiment of the present invention, the carbon dioxide produced by the process (for example in any of the one or more reactors and in the combustor) is sequestered and stored so that it is not released into the atmosphere. Preferably this is achieved by feeding the carbon dioxide into an oil and/or gas well, which ensures that the carbon dioxide is unlikely to be released to the atmosphere, while simultaneously enabling improved extraction of oil and/or gas therefrom.

The carbon dioxide is preferably dried before sequestration to prevent potential corrosion problems. This is typically achieved by cooling the wet carbon dioxide stream to ambient temperature, typically below 50° C., preferably below 40° C., and feeding it to a water separator, in which the water condenses and is separated from a dewatered gas phase carbon dioxide stream. The condensed water can optionally be re-used in the process, for example as feed to one or more of the steam reforming and/or partial oxidation reactors.

For process streams from the first zone of one or more of the reactors having low concentrations of hydrogen and low concentrations of carbon monoxide, for example process streams having carbon monoxide molar concentrations of less than 5%, the energy liberated on combustion may be too low to significantly benefit process efficiency. In such circumstances, it may be preferable to feed the process stream directly to the water separator without any prior combustion. The carbon dioxide in the dewatered carbon dioxide stream is then separated from any remaining hydrogen by compressing the stream to a pressure at which carbon dioxide densifies or liquefies, which typically occurs at pressures above 70 barg (7.1 MPa). Preferably, the stream is compressed to a pressure in the range of from 75 to 100 barg (7.6 to 10.1 MPa). The hydrogen-containing gas phase stream is separated from the densified or liquefied carbon dioxide, may be recycled to one of the membrane-containing reactors, or may alternatively be combusted to heat a steam supply, for example. If the gas phase hydrogen-containing stream is sufficiently pure in hydrogen, then it may alternatively be combined with permeated hydrogen from the second zone of the one or more reactors.

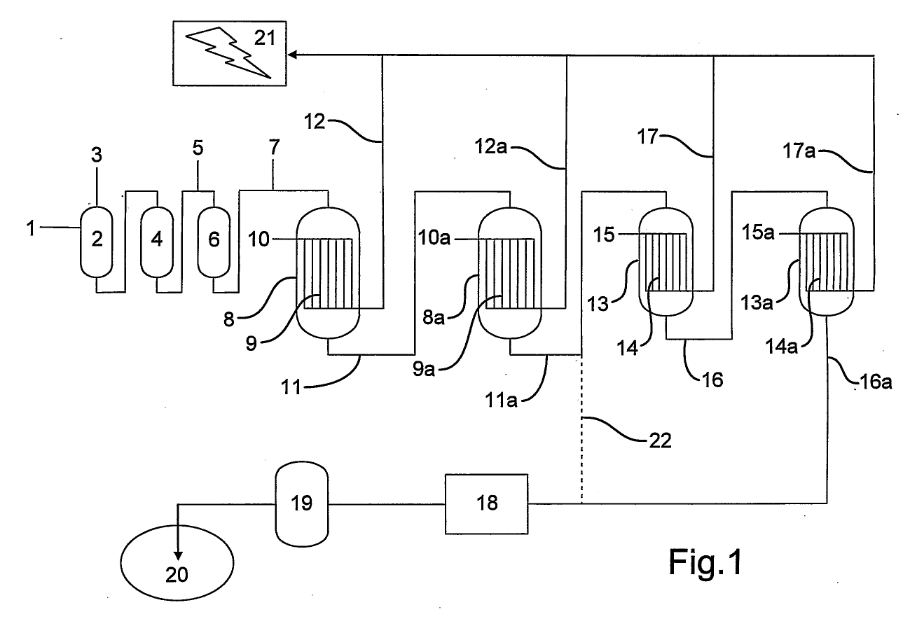

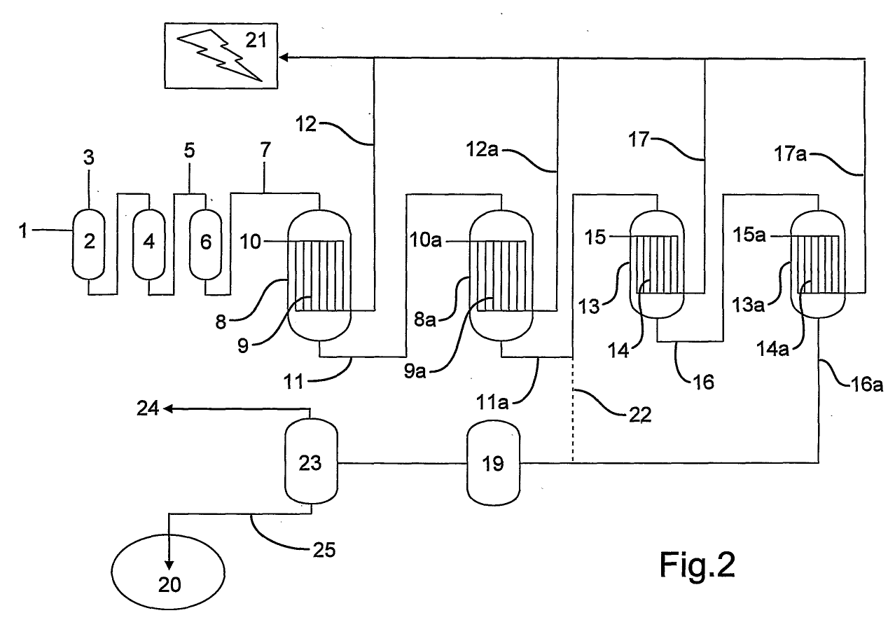

The invention will now be illustrated by reference to FIGS. 1 and 2 in which;

FIG. 1 is a schematic illustration of a process in accordance with the present invention in which hydrogen is separated from a COₓ stream derived from steam reforming and partial oxidation of natural gas and fed to a power generator, wherein the COₓ stream is fed to a combustor, optionally via water gas shift reactors, wherein it is combusted to generate carbon dioxide, which is dewatered and sequestered.

FIG. 2 is a schematic illustration of an alternative process in accordance with the present invention, in which the carbon dioxide in a COₓ process stream from steam reforming and/or WGS reactors is not combusted, but is instead dewatered and compressed to a pressure where carbon dioxide densities or liquefies, wherein it is separated from a gas phase hydrogen-containing stream and sequestered.

In the process illustrated in FIG. 1, natural gas 1 and a supply of hydrogen 3 is fed to a mercaptan removal unit 2, in which the mercaptan is converted to H₂S over a cobalt-containing catalyst. The hydrogen stream 3 fed to the mercaptan removal unit 2 may be removed as a slip stream from hydrogen produced in other parts of the same process, or may be supplied from elsewhere.

A process stream is removed from the mercaptan removal unit and fed to a desulphurisation unit 4, in which sulphurous residues, such as hydrogen sulphide created by the mercaptan removal unit, are removed by an absorbent, such as zinc oxide.

The process stream removed from the desulphursation unit is combined with medium pressure steam 5, and fed to pre-reformer 6 operating at approximately 550° C. in which higher hydrocarbons, such as ethane, propane and butanes, are converted to hydrogen and COₓ.

The process stream removed from the pre-reformer is combined with oxygen 7 and a further supply of medium pressure steam (not shown), and fed to reactor 8 comprising a combined steam reforming and partial oxidation catalyst, and which operates at a pressure of 25 barg (2.6 MPa), and a temperature of 550° C. Within the reactor 8, there is a bank of hollow tubes each supporting a palladium membrane 9 which is selectively permeable to hydrogen. Apart from any permeation through the membrane, the interior of the tubes are otherwise isolated from the contents of reactor 8.

The contents of reactor 8 that do not permeate the selectively permeable membrane, 9, and which comprise non-permeated hydrogen, unreacted methane, and COₓ, are removed through line 11 and fed to a second reactor 8a, also comprising a bank of palladium-membrane covered tubes, 9a. Reactor 8a is operated in an analogous way to reactor 8.

A pressurised supply of nitrogen 10 (and 10a), at a pressure in the range of from 20 to 25 barg (2.1 to 2.6 MPa) is fed to the interior of the palladium-coated tubes 9 (and 9a). The combined hydrogen/nitrogen stream, in a molar ratio of approximately 1:1, is removed through line 12 (or 12a), compressed to about 25 barg (2.6 MPa) if necessary, and fed to power generator 21, in which the hydrogen is combusted in a combined cycle gas turbine for generating electricity and pressurised steam.

The COₓ-containing stream is then optionally fed to a high temperature WGS reactor 13, also containing a bank of palladium membrane-coated tubes 14. The high temperature WGS reactor comprises a high temperature WGS catalyst, and is operated at a temperature of 340° C. and a pressure of 25 barg (2.6 MPa). A feed of nitrogen 15 at a pressure in the range of from 20 to 25 barg (2.1 to 2.6 MPa) is fed to the interior of the palladium membrane-coated tubes 14, and the combined hydrogen/nitrogen stream removed through line 17.

A stream comprising CO₂, water, unconverted CO and un-permeated hydrogen is removed from the WGS reactor 13, and fed to a second WGS reactor 13a operating at a lower temperature of 250° C. Palladium-membrane coated tubes 14a, nitrogen feed 15a, and nitrogen/hydrogen line 17a are analogous to the features of the first WGS reactor 14, 15 and 17 respectively.

The nitrogen and hydrogen-containing stream comprising permeated hydrogen from the WGS reactors is combined with the hydrogen removed in the steam reforming reactors, compressed to 25 barg (2.6 MPa)-if necessary, and fed to power generator 21.

The COₓ-containing stream 16a removed from reactor 13a is fed to a combustor 18, in which unreacted hydrocarbon; un-permeated hydrogen and any remaining carbon monoxide are combusted in the presence of oxygen. The product stream from the combustor, which almost exclusively comprises carbon dioxide and water, is cooled to a temperature of approximately 30° C. and fed to a water separator 19, in which the water condenses and is removed from the carbon dioxide. The remaining carbon dioxide is compressed to a pressure typically in the range of from 100 to 200 bara (10 to 20 MPa), and fed into an oil and/or gas well 20.

In an alternative embodiment of the process, there are no WGS reactors, and the COₓ-containing process stream removed from the second steam reforming reactor 8a comprising carbon monoxide at a molar concentration of less than 10% is fed directly to combustion unit 18 via line 22.

In the process of FIG. 2, there is no combustor. Instead, the CO₂-containing stream 22 from the first zone of partial oxidation and steam reforming reactor 8a, or the process stream 16a from water gas shift reactor 13a, in which the molar carbon monoxide concentration is less than 5%, is cooled to approximately 30° C. before being fed to water separator 19. The dewatered gaseous stream is fed to a carbon dioxide separator 23 at a pressure of approximately 88 barg (8.9 MPa), wherein a gas phase stream 24 comprising hydrogen is removed from a stream comprising densified or liquefied CO₂ 25, which densified or liquefied CO₂ is sequestered by being further compressed to a pressure in the range of from 100 to 200 bara (10 to 20 MPa) before being fed into an oil and/or gas well 20.

1. A process for the production of hydrogen from a hydrogen-containing compound in a reactor having a first zone and a second zone separated by a selective hydrogen-permeable membrane, which process comprises the steps of;
(a) feeding a hydrogen-containing compound into the first zone of the reactor;
(b) maintaining conditions therein such that the hydrogen-containing compound reacts to produce hydrogen;
(c) maintaining conditions in the second zone of the reactor such that hydrogen produced in the first zone permeates across the selective hydrogen-permeable membrane to the second zone;
(d) removing from the first zone of the reactor a stream comprising components that have not permeated through the selective hydrogen-permeable membrane; and
(e) removing from the second zone of the reactor a stream comprising hydrogen that has permeated across the selective hydrogen-permeable membrane, the hydrogen partial pressure being maintained at a value of greater than 30 psi (207 kPa), characterised in that a sweep gas is also fed to the second zone of the reactor.

2. A process as claimed in claim 1, in which the molar concentration hydrogen in the stream removed from the second zone of the reactor in step (e) is maintained at a level suitable for the stream to be used as a fuel for a gas turbine.

3. A process as claimed in claim 1, in which the sweep gas is nitrogen and/or steam.

4. A process as claimed in claim 1, in which the molar hydrogen (H₂) concentration in the second zone of the reactor is up to 80%.

5. A process as claimed in claim 4, in which the molar hydrogen concentration in the second zone of the reactor is in the range of from 40% to 60%.

6. A process as claimed in claim 1, in which the hydrogen partial pressure in the second zone of the reactor is 3 bar (0.3 MPa) or more.

7. A process as claimed in claim 1, in which the total pressure in the second zone of the reactor is at least 10 bara (1 MPa).

8. A process as claimed in claim 1, in which the reaction in the first zone of the reactor is selected from one or more of a water gas shift reaction, a partial oxidation reaction and a steam reforming reaction.

9. A process as claimed in claim 8, in which the reaction in the first zone is a combined partial oxidation and steam reforming reaction.

10. A process as claimed in claim 1, in which the reaction in the first zone of the reactor is catalysed.

11. A process as claimed in claim 1, in which the process stream removed from the first zone of the reactor is fed to a combustor to produce heat and a product stream predominantly comprising carbon dioxide and water.

12. A process as claimed in claim 11, in which the heat generated in the combustor is transferred to one or more feed streams to the first zone of the reactor.

13. A process as claimed in claim 11, in which the combustor product stream is fed to a water separator in which water is removed from the carbon dioxide by condensation.

14. A process as claimed in claim 1, in which the process stream removed from the first zone of the reactor comprises carbon monoxide at a molar concentration of less than 5%.

15. A process as claimed in claim 14, in which the process stream removed from the first zone of the reactor is fed to a water separator, wherein water condenses and is separated from a gas phase carbon dioxide stream.

16. A process as claimed in claim 15, in which the dewatered carbon dioxide-containing product stream from the first zone of the reactor is compressed to a pressure where carbon dioxide densities or liquefies, and is separated from a gas phase hydrogen-containing stream.

17. A process as claimed in claim 16, in which the dewatered carbon dioxide-containing product stream from the first zone of the reactor is compressed to a pressure in the range of from 75 to 100 barg (7.6 to 10.1 MPa).

18. A process as claimed in claim 13, in which the remaining carbon dioxide-containing stream is sequestered.

19. (canceled)

20. A process as claims in claim 16, in which the remaining carbon dioxide-containing stream is sequestered.

21. A process as claimed in claim 19, in which the remaining carbon dioxide-containing stream is sequestered by being compressed to a pressure in the range of from 100 to 200 bara (10 to 20 MPa) and fed into an oil and/or gas well.
